(19) United States
(12) Patent Application Publication
(10) Pub. No.: US 2018/0361498 A1
(43) Pub. Date: Dec. 20, 2018

(54) WELDING METHODS INCLUDING FORMATION OF AN INTERMEDIATE JOINT USING A SOLID STATE WELDING PROCESS

(71) Applicant: Ohio State Innovation Foundation, Columbus, OH (US)

(72) Inventors: Wei Zhang, Dublin, OH (US); Ying Lu, Columbus, OH (US); Ellis Mayton, Royal Oak, MI (US); Menachem Kimchi, Westville, OH (US)

(21) Appl. No.: 16/006,903

(22) Filed: Jun. 13, 2018

Related U.S. Application Data
(60) Provisional application No. 62/519,300, filed on Jun. 14, 2017.

(51) Int. Cl. B23K 11/11; B23K 20/10; B23K 20/233; B23K 20/227

(52) U.S. Cl. CPC B23K 11/115; B23K 20/10; B23K 2203/04; B23K 20/2333; B23K 20/227; B23K 20/2336

(57) ABSTRACT

An example method for joining metals is described herein. The method can include forming an intermediate joint between a first structural member and a foil member, where the intermediate joint is formed using a solid state welding process. The method can also include forming a primary joint between the first structural member and a second structural member, where the primary joint is formed using a welding process that produces coalescence at a temperature above the melting point of the first structural member or the second structural member.

### CROSS-REFERENCE TO RELATED APPLICATIONS

This application claims the benefit of U.S. provisional patent application No. 62/519,300, filed on Jun. 14, 2017, and entitled “WELDING METHODS INCLUDING FORMATION OF AN INTERMEDIATE JOINT USING A SOLID STATE WELDING PROCESS,” the disclosure of which is expressly incorporated herein by reference in its entirety.

### BACKGROUND

Aluminum (Al) and magnesium (Mg) alloys are two light-weight metals increasingly used in automotive body-in-white (BIW) structures to reduce vehicle weight and thus increase fuel efficiency. A light yet crash-resistant body structure is especially important for electrical vehicles (EVs) to extend their driving range. The next generation of vehicles is anticipated to have a multi-material body structure including advanced high-strength steels (AHSS) and Al and Mg alloys. Hence, robust and cost-effective joining of dissimilar metals (e.g., AHSS to Al, and AHSS to Mg) is critical to enable such multi-material body structures. The dissimilar metal joining has remained a major technical challenge due to the large difference in thermal-physical properties between AHSS and Al/Mg as well as the formation of brittle intermetallic components (IMCs) at the joint.

It is noted that a variety of solid-state joining and mechanical riveting processes have been developed for the dissimilar metal joining of AHSS to Al/Mg. These processes include friction element welding, friction stir scribe welding, friction bit joining, self-piercing riveting, and vaporizing foil actuator welding. Each of these processes has its strengths and drawbacks. Moreover, a widespread application of these processes in the mass-production environment is still limited as each would require changing the assembly line with costly new joining equipment.

### SUMMARY

Described herein are methods for metal joining that make use of the existing assembly line infrastructure. The methods can be used to join dissimilar metals (e.g., AHSS to Al, and AHSS to Mg). The current de facto process for assembling automotive body structures is resistance spot welding (RSW). For example, a body structure typically contains 3000 to 5000 spot welds. However, dissimilar joining of AHSS to Al or Mg using RSW is difficult as the joint is brittle due to the severe formation of IMCs. As described below, ultrasonic plus resistance spot welding (U+RSW) can enable the direct joining of AHSS to Al or Mg using the existing RSW machines.

An example method for joining metals is described herein. The method can include forming an intermediate joint between a first structural member and a foil member, where the intermediate joint is formed using a solid state welding process. The method can also include forming a primary joint between the first structural member and a second structural member, where the primary joint is formed using a welding process that produces coalescence at a temperature above the melting point of the first structural member or the second structural member.

Additionally, the primary joint can be formed to at least partially overlap with the intermediate joint. Alternatively or additionally, the intermediate joint can be selectively formed at a desired location of the primary joint before forming the primary joint.

Alternatively or additionally, the intermediate joint can be a metallurgical bond. In some implementations, the solid state welding process used to form the intermediate joint can roughen a surface of the foil member.

Alternatively or additionally, the solid state welding process used to form the intermediate joint can be an ultrasonic welding process or an impact welding process. Alternatively or additionally, the welding process used to form the primary joint can be resistance welding, projection welding, or a capacitive discharge welding process. For example, in some implementations, the solid state welding process used to form the intermediate joint can be ultrasonic spot welding, and the welding process used to form the primary joint can be resistance spot welding.

Alternatively or additionally, in some implementations, the first and second structural members can be dissimilar metals. For example, the first structural member can be steel, titanium (Ti), or nickel (Ni), and the second structural member can be aluminum (Al), magnesium (Mg), copper (Cu), or beryllium (Be). Optionally, the first structural member can be titanium (Ti), and the second structural member can be nickel (Ni) or steel. Optionally, the first structural member can be one of aluminum (Al) or magnesium (Mg), and the second structural member can be the other of Al or Mg.

Alternatively or additionally, in some implementations, the first and second structural members can be similar metals. Optionally, each of the first and second structural members can be aluminum (Al) or magnesium (Mg).

Alternatively or additionally, the foil member can be aluminum (Al), magnesium (Mg), nickel (Ni), titanium (Ti), copper (Cu), molybdenum (Mo), tantalum (Ta), or a high entropy alloy.

Alternatively or additionally, a thickness of intermetallic compounds at the interface between the first and second structural members after formation of the primary joint is sufficiently thin to avoid a detrimental effect on mechanical properties of the primary joint.

Alternatively or additionally, a strength of the primary joint is greater than a minimum required by a relevant industry standard.

Alternatively or additionally, the method can include providing a sealant layer between the first structural member and the foil member before forming the intermediate joint. Optionally, the sealant layer can be an adhesive.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 illustrates a method for joining metals using ultrasonic plus resistance spot welding (U+RSW) according to an implementation described herein.

FIG. 2A illustrates the first structural member and foil described in FIG. 1, which are joined using ultrasonic spot welding (USW). FIG. 2B illustrates an example USW machine. FIG. 2C illustrates the first structural member, the second structural member, the foil, and the intermediate joint described in FIG. 1. FIG. 2D illustrates an example RSW machine.

FIG. 3 is a chart illustrating the joint strength in lap-shear tensile testing as a function of welding current used in the second step of U+RSW to create a primary weld, for example, a primary joint as described in FIG. 1.

FIG. 4 illustrates a button-pull-out failure mode (joint strength=3.4 kN) for a primary weld, for example, a primary joint as described in FIG. 1.

FIGS. 5A and 5B illustrate the microstructure for a primary weld, for example, a primary joint as described in FIG. 1. FIG. 5A illustrates IMCs formed at the Al/steel interface after formation of the intermediate joint. FIG. 5B illustrates IMC growth at the Al/steel interface after formation of the primary joint.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. While implementations will be described for ultrasonic plus resistance spot welding (U+RSW), it will become evident to those skilled in the art that the implementations are not limited thereto, but are applicable for other processes including, but not limited to, ultrasonic plus resistance seam welding. Additionally, the implementations described herein are also applicable to other welding processes, for example, where the intermediate joint is formed using a solid state welding process followed by formation of a primary joint using a welding process producing coalescence.

An example method for joining metals is described herein. In some implementations, the method can be used to join dissimilar metals. For example, the method can be used to join first and second structural members, where the first structural member can be steel, titanium (Ti), or nickel (Ni), and the second structural member can be aluminum (Al), magnesium (Mg), copper (Cu), or beryllium (Be). This disclosure contemplates that steel includes, but is not limited to, carbon steel, high strength low alloy (HSLA) steel, advanced high strength steel (AHSS), or stainless steel. Additionally, this disclosure contemplates that the elemental specification (e.g., Ti, Al, etc.) includes both pure metal (e.g., commercially pure Ti, Al, etc.) and its alloys (e.g., Ti-6AL-4V, AA 6061). Optionally, the first structural member can be titanium (Ti), and the second structural member can be nickel (Ni) or steel. Optionally, the first structural member can be one of aluminum (Al) or magnesium (Mg), and the second structural member can be the other of Al or Mg. In other implementations, the method can be used to join similar metals. For example, the method can be used to join first and second structural members, where each of the first and second structural members can be aluminum (Al) or magnesium (Mg).

An example method for joining first and second structural members is described below. This disclosure contemplates that the structural members can be similar or dissimilar metals as described herein. In a first step, the method includes forming an intermediate joint between a first structural member and a foil member. The foil member can include, but is not limited to, aluminum (Al), magnesium (Mg), nickel (Ni), titanium (Ti), copper (Cu), molybdenum (Mo), tantalum (Ta), or a high entropy alloy. The intermediate joint can be a metallurgical bond between the first structural member and foil. The intermediate joint can be formed using a solid state welding process. It should be understood that solid state welding processes produce coalescence below the melting point of the metals. Solid state welding processes are known in the art. For example, solid state welding processes include, but are not limited to, ultrasonic welding or impact welding. In a second step, after forming the intermediate joint using the solid state welding process, the method includes forming a primary joint between the first structural member and a second structural member. The primary joint can be formed using a welding process that produces coalescence at a temperature above the melting point of the first structural member or the second structural member. Welding processes producing coalescence at a temperature above the melting point of metal(s) are known in the art. For example, such welding processes include, but are not limited to resistance welding, projection welding, or a capacitive discharge welding process. As an example below, an ultrasonic plus resistance spot welding technique is described. This disclosure contemplates that techniques involving other solid state welding processes to form the intermediate joint and/or other welding processes to form the primary joint can be implemented according to this disclosure.

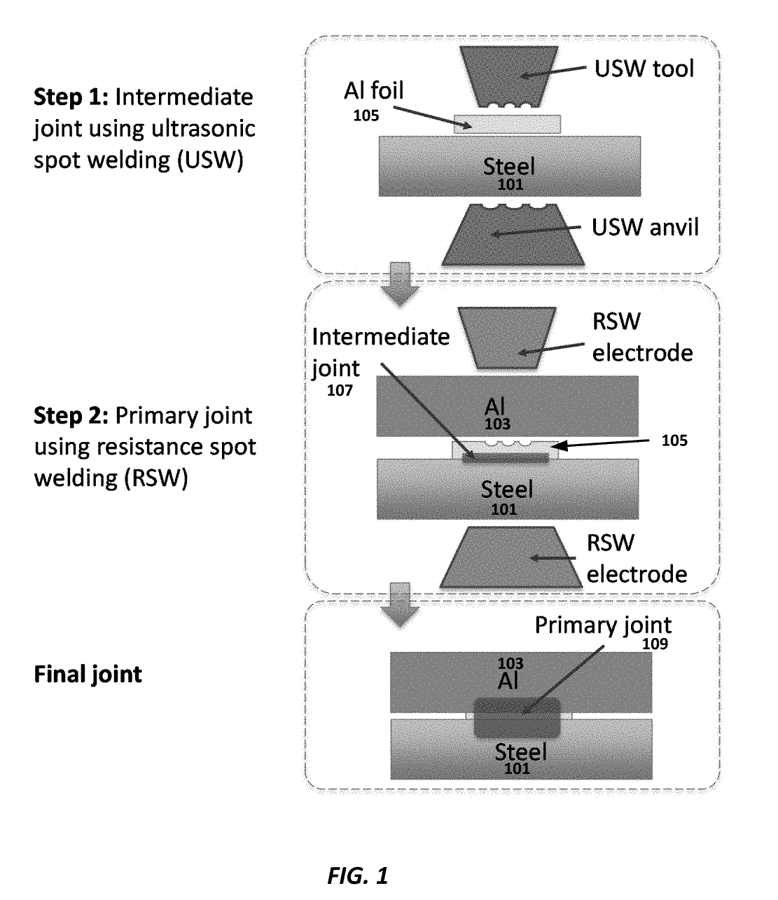

Referring now to FIG. 1, a method for joining metals using ultrasonic plus resistance spot welding (U+RSW) is shown. U+RSW involves two steps, as shown in FIG. 1. U+RSW can be used to join a first structural member 101 and a second structural member 103. In FIG. 1, the first structural member 101 is steel (e.g., AISI 1008 carbon steel). It has a thickness of 1 millimeter (mm). In FIG. 1, the second structural member 103 is Al (e.g., Al 6061-T6). It has a thickness of 1 mm. It should be understood that the materials and/or thicknesses used for the first and second structural members 101, 103 in FIG. 1 are provided only as examples. As described herein, the joined metals can be similar or dissimilar metals. The first and second structural members 101, 103 can also have thicknesses other than those shown in FIG. 1. Alternatively or additionally, the first structural member 101 and/or the second structural member 103 can include multiple sheets of the similar material. For example, the first structural member 101 can include a plurality of steel sheets (e.g., 2 sheets), and the second structural member 103 can include a plurality of Al sheets (e.g., 2 sheets). It should be understood that the number of sheets and materials are provided only as examples and that this disclosure contemplates using different numbers of sheets and/or materials with the techniques described herein.

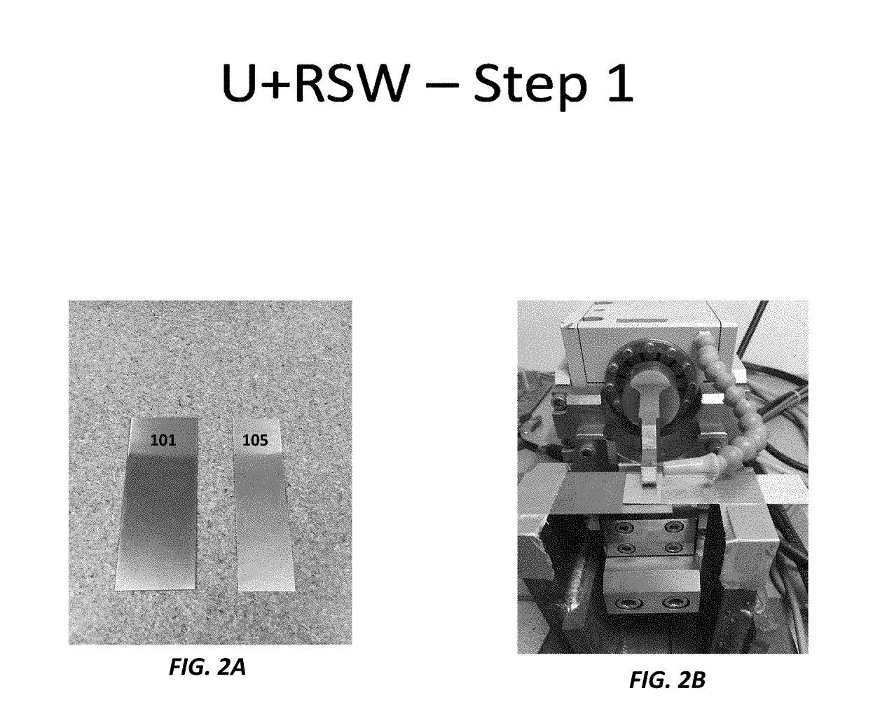

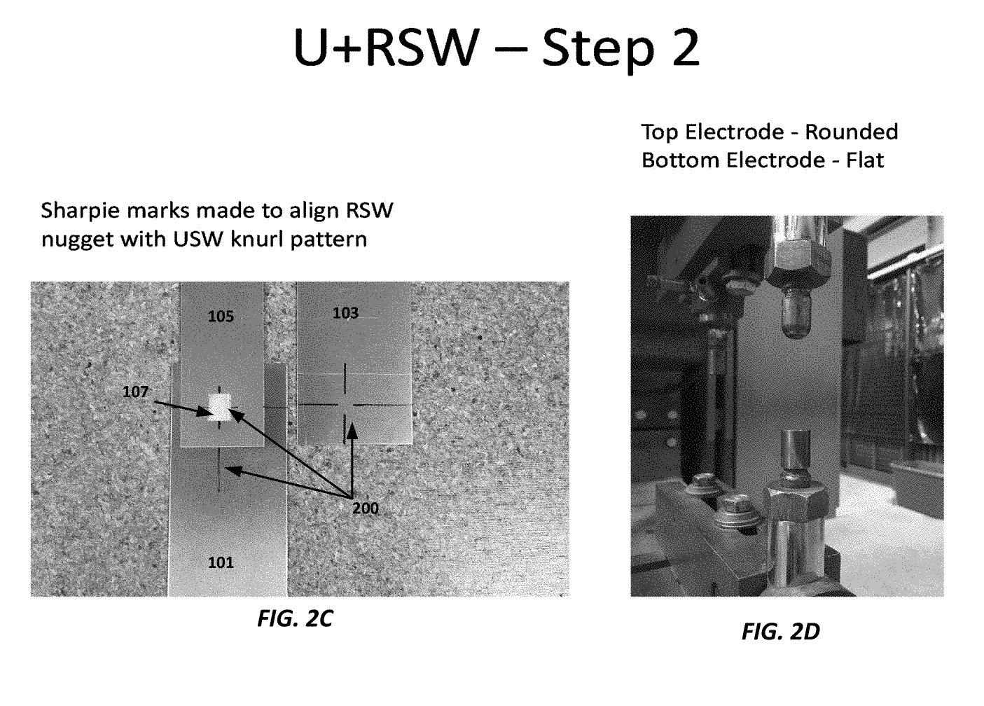

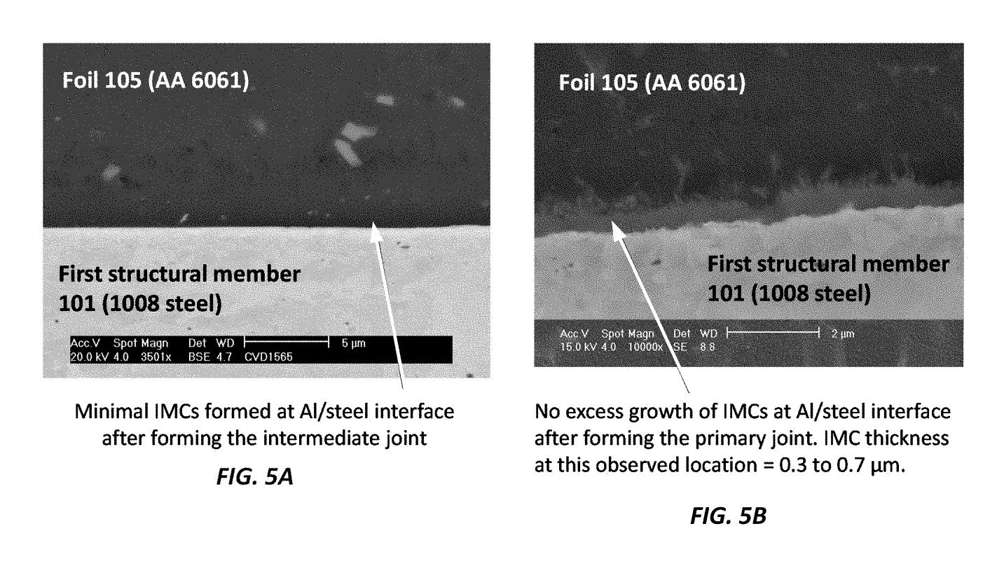

In Step 1, an intermediate joint 107 is formed between the first structural member 101 and a foil 105 (e.g., an Al foil) using ultrasonic spot welding (USW). In FIG. 1, the foil 105 is Al (e.g., Al 6061-T6). It has a thickness of 0.4 mm. The foil 105 can optionally be other low cost commercial Al foil, which can be used to join steel to Al. When joining other metals, other low cost commercial foils can be used depending on the materials to be joined. It should be understood that the material and/or thickness used for the foil 105 in FIG. 1 are provided only as examples. USW is a solid state welding process. In other words, the intermediate joint 107 between the first structural member 101 and the foil 105 is formed using a solid state welding process (e.g., USW in FIG. 1). In this step, an ultrasonic vibration (e.g., 20-kHz-frequency and 50-μm-amplitude) is applied by the USW tool. The first structural member 101 and the foil 105 are also shown in FIG. 2A. An example USW machine is shown in FIG. 2B. The back-and-forth “rubbing” action at the workpieces' interface breaks up and disperses surface oxide, which is a main barrier for bonding. Moreover, the frictional heating softens the joint area to form a sound bond. In FIG. 1, the intermediate joint 107 is a metallurgical bond. Given the short cycle time (e.g., about 0.4 seconds), the IMCs formed at the intermediate joint is minimal. This is shown in FIG. 5A which illustrates IMCs formed at the Al/steel interface after formation of the intermediate joint (e.g., intermediate joint 107 in FIG. 1). In FIG. 1, the USW tool and anvil have a knurled surface to facilitate the gripping of workpieces. The knurl pattern results in a mirror imprint in the foil 105, which facilitates the formation of a primary joint 109 in the subsequent step of the U+RSW process. Optionally, in some implementations, a sealant layer (e.g., an adhesive) can be provided between the first structural member 101 and the foil member 105 before forming the intermediate joint 107.

In Step 2, the primary joint 109 is formed between the first structural member 101 and the second structural member 103 using resistance spot welding (RSW). The second structural member 103 is welded to the first structural member 101 through the foil 105. RSW is a welding process that produces coalescence above the melting point of the first structural member 101 and/or the second structural member 103. The “roughened” surface of the foil 105 can facilitate the local heat generation to form the primary joint 109. This disclosure contemplates that the surface of the foil 105 can be roughened, for example, using sandpaper before performing RSW. Moreover, as the foil 105 and first structural member 101 are already bonded by the intermediate joint 107, an excess growth of IMCs at the Al/steel joint (i.e., the interface between the first structural member 101 and the foil 105) is much less likely to occur than that in RSW of Al to steel directly (i.e., RSW without formation of an intermediate joint). This is shown in FIG. 56, which illustrates slight IMC growth at the Al/steel interface after formation of the primary joint (e.g., primary joint 109 in FIG. 1). The foil 105 can be chosen to be metallurgically compatible with the second structural member 103 such that no, or a minimal amount of, brittle IMCs would form at the interface between the foil 105 and the second structural member 103 after forming the primary joint 109. A metallurgically compatible pair can include similar metals (e.g., Al for both foil 105 and second structural member 103) or dissimilar metals (e.g., Al for foil 105 and Mg for second structural member 103).

In FIG. 1, the primary joint 109 is formed to at least partially overlap with the intermediate joint 107. For example, FIG. 2C illustrates the first structural member 101, the second structural member 103, the foil 105, and the intermediate joint 107. In FIG. 2C, markings 200 are provided to align the RSW nugget with USW knurl pattern. In this way, the intermediate joint 107 can be selectively formed at a desired location of the primary joint 109 before forming the primary joint 109. Optionally, a plurality of intermediate joints can be formed using USW at respective locations for a plurality of primary joints to be formed using RSW. An example RSW machine is shown in FIG. 2D.

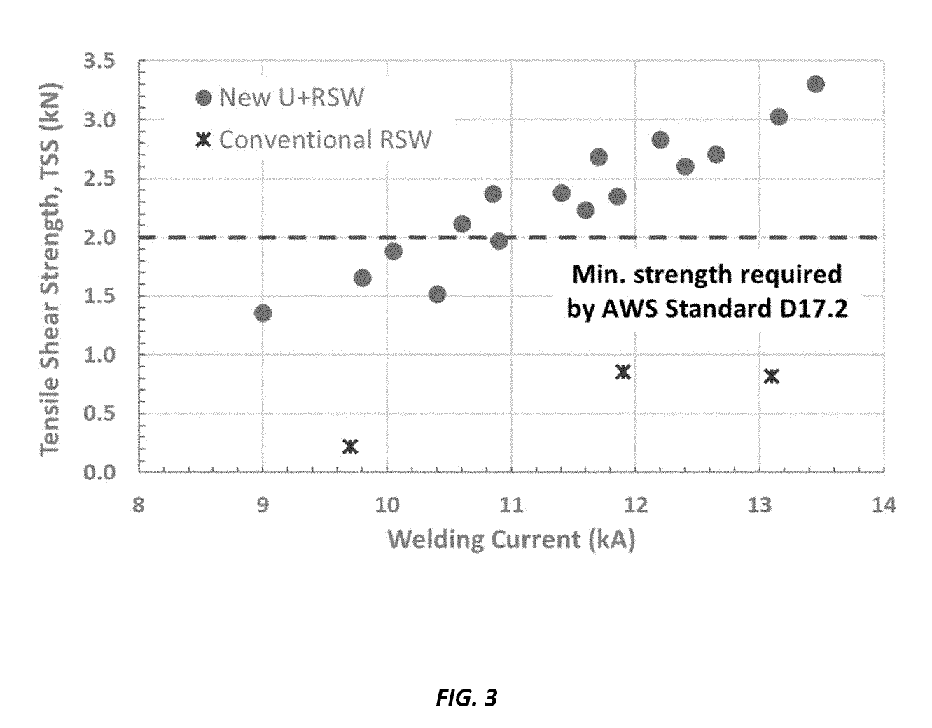

Referring now to FIG. 3, the joint strength in lap-shear tensile testing is shown as a function of welding current used in the second step of U+RSW to create the primary weld (e.g., primary joint 109 in FIG. 1). As shown in FIG. 3, the joint strength (illustrated with circles or dots in FIG. 3) increases with the weld current, a desirable behavior that is commonly observed in RSW of steel to steel. In other words, higher RSW weld currents yield stronger bonds. Moreover, the joint strength produced by U+RSW (up to 3.4 kilo Newton (kN)) is well above the minimal requirement by relevant industry standard (e.g., 2 kN for 1-mm-thick aluminum alloy 6061-T6). The relevant industry standard (AWS Standard D17.2) is shown by a dotted line. This is not the case for a joint formed by RSW without the intermediate joint, where joint strength is less than the relevant industry standard. Joint strength of a weld formed using the conventional RSW process is illustrated for comparison in FIG. 3. It is well below (e.g., about 1 kN) the relevant industry standard shown in FIG. 3. It should be understood that desired joint strength depends on factors such as types and/or thicknesses of the materials. FIG. 3 illustrates only an example based on the primary joint formed using U+RSW as described in FIG. 1. Additionally, relevant industry standards include, but are not limited to, American Welding Society (AWS) standards or other industry standards such as standards established by other organizations and/or companies (e.g., FORD, GENERAL MOTORS, GENERAL ELECTRIC, etc.). In FIG. 3, when the second step (i.e., formation of the primary weld) is carried out with weld current above about 11 kA, the joint strength exceeds a relevant industry standard (e.g., AWS Standard D17.2 in FIG. 3). It should be understood that weld currents in this range (e.g., 11-14 kA) are common in industrial applications. It should also be understood that welding current can vary depending on the materials and/or thicknesses of metals to be joined.

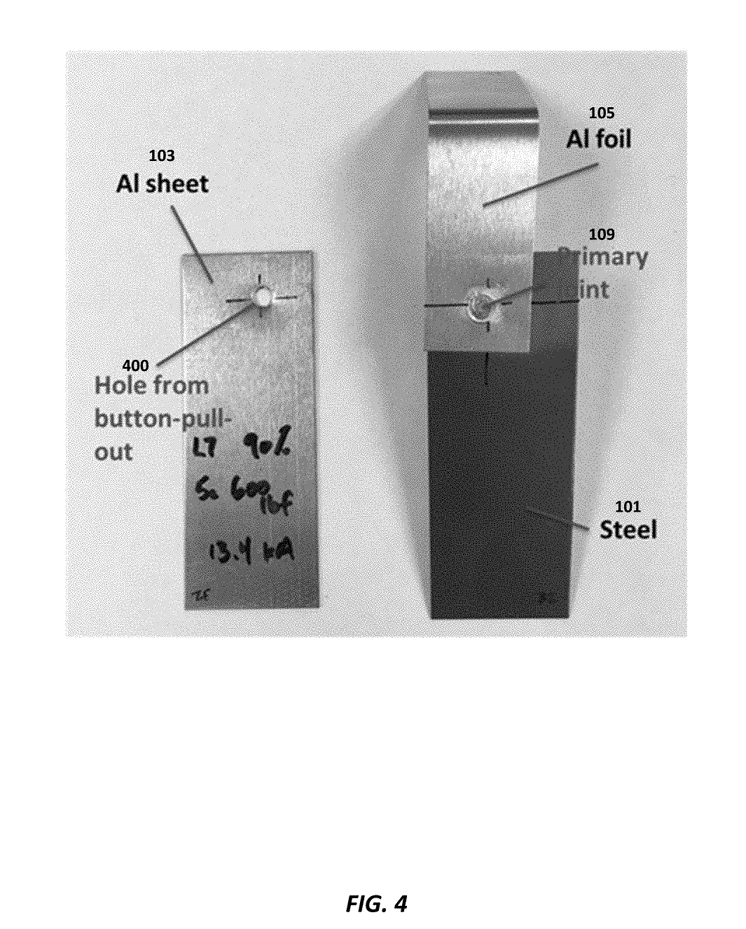

Referring now to FIG. 4, a button-pull-out failure mode (joint strength=3.4 kN) is shown for the primary weld (e.g., primary joint 109 in FIG. 1). The first structural member 101, the second structural member 103, the foil 105, and the primary joint 109 are shown in FIG. 4. The hole 400 from the button-pull-out is also shown in FIG. 4. Button-pull-out failure is a desirable failure mode indicating the soundness and strength of the joint. For comparison, a direct RSW between Al and steel would fail in an interfacial mode at low peak load due to the brittle IMCs present at the interface.

Referring now to FIG. 5B, the microstructure at the Al/steel joint (e.g., the interface between the first structural member 101 and the foil 105 in FIG. 1) after forming the primary joint is shown. There is no excess formation of intermetallic compounds (IMCs), which weaken the bond, in FIG. 5B. In particular, the thickness of intermetallic compounds at the interface between the joined metals (e.g., first structure member 101 and foil 105 in FIG. 1) after formation of the primary joint (e.g., primary joint 109 in FIG. 1) is sufficiently thin to avoid a detrimental effect on mechanical properties of the primary joint. As shown in FIG. 5B, the thickness of intermetallic components (e.g., FeAl₃, Fe₂Al₅) along the Al/steel interface is less than 2 micrometers (μm), and it is only 0.3 to 0.7 μm at some locations.

As supported by the results illustrated in FIGS. 3-56, the feasibility of U+RSW for dissimilar metal joining steel to Al has been demonstrated. The benefits of U+RSW include:

(1) Ability to weld a large range of dissimilar materials. Although dissimilar metal joining of steel to Al is described above, this disclosure contemplates U+RSW can be advantageous for joining other dissimilar metal combinations as well as similar Al to Al and Mg to Mg with improved robustness compared to the conventional RSW.

| Material A | Material B | |
|---|---|---|
| (e.g., first | (e.g., second | |
| structural | structural | |
| member) | member) | Example Materials |
| Steel | Al | Different steels such as high strength low alloy |
| | | steels, stainless steels, and ferritic-martensitic |
| | | steels |
| Steel | Mg | Different AHSS (e.g., DP, TRIP, press |
| | | hardenable (or hot-formed) steels |
| Al | Mg | Different coatings on steel |
| Ti | Ni | Different Al alloys (e.g., 5xxx and 7xxx series) |
| Ti | Steel | Different Mg alloys |
| Ti | Al | Other alloys such as titanium alloys, nickel |
| | | base alloys, copper alloys and beryllium alloys |
| Al | Al | Different thicknesses |
| Mg | Mg | Welding through adhesives |

(2) Flexibility in joint geometry. Any geometry that can be welded by the conventional RSW can be welded by U+RSW. Particular, U+RSW can be used for 2T (two sheets) and multiple sheets (e.g., 3T such as Al to steel A to steel B). Moreover, the principle can be extended to dissimilar metal seam welding such as resistance seam welding.

(3) Low capital cost and fast cycle time with USW. USW is a well-established and widely-used process in automotive and electronics industries. An ultrasonic spot welder costs on the order of $50K, which is an order of magnitude cheaper than the solid-state spot welder mentioned earlier. The cycle time is very short (about 0.4 s or less), comparable to that of RSW. In addition, USW consumes much lower energy when compared to RSW. For example, welding of aluminum alloys using a USW process consumes only about 0.3 kWh per 1 000 joints, when compared to 20 kWh with RSW, and 2 kWh with friction stir spot welding (FSSW). Finally, the consumable cost is essentially negligible as only thin Al (or Ni) foils are used. On the contrary, the rivets and bits used by self-piercing riveting and friction bit joining are specially made and much costlier. Hence, a USW welder is expected to be readily integrated into the mass-production assembly line.

U+RSW is a break-through process for dissimilar metal joining. This disclosure contemplates using U+RSW in automotive and other manufacturing industry applications. Its feasibility has been fully demonstrated for joining steel to Al. The technology has a high potential to become a game-changer for the automotive original equipment manufacturers (OEMs).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for joining metals, comprising:
forming an intermediate joint between a first structural member and a foil member, wherein the intermediate joint is formed using a solid state welding process; and
forming a primary joint between the first structural member and a second structural member, wherein the primary joint is formed using a welding process that produces coalescence at a temperature above the melting point of the first structural member or the second structural member.

2. The method of claim 1, wherein the primary joint is formed to at least partially overlap with the intermediate joint.

3. The method of claim 1, wherein the intermediate joint is selectively formed at a desired location of the primary joint before forming the primary joint.

4. The method of claim 1, wherein the intermediate joint is a metallurgical bond.

5. The method of claim 1, wherein the solid state welding process used to form the intermediate joint roughens a surface of the foil member.

6. The method of claim 1, wherein the solid state welding process used to form the intermediate joint is an ultrasonic welding process or an impact welding process.

7. The method of claim 1, wherein the welding process used to form the primary joint is resistance welding, projection welding, or a capacitive discharge welding process.

8. The method of claim 1, wherein the solid state welding process used to form the intermediate joint is an ultrasonic spot welding process, and the welding process used to form the primary joint is resistance spot welding.

9. The method of claim 1, wherein the first and second structural members are dissimilar metals.

10. The method of claim 9, wherein the first structural member comprises steel, titanium (Ti), or nickel (Ni).

11. The method of claim 9, wherein the second structural member comprises aluminum (Al), magnesium (Mg), copper (Cu), or beryllium (Be).

12. The method of claim 9, wherein the first structural member comprises titanium (Ti), and wherein the second structural member comprises nickel (Ni) or steel.

13. The method of claim 9, wherein the first structural member comprises one of aluminum (Al) or magnesium (Mg), and wherein the second structural member comprises the other of Al or Mg.

14. The method of claim 1, wherein the first and second structural members are similar metals.

15. The method of claim 14, wherein each of the first and second structural members comprises aluminum (Al) or magnesium (Mg).

16. The method of claim 1, wherein the foil member comprises aluminum (Al), magnesium (Mg), nickel (Ni), titanium (Ti), copper (Cu), molybdenum (Mo), tantalum (Ta), or a high entropy alloy.

17. The method of claim 1, wherein a thickness of intermetallic compounds at the interface between the first and second structural members after formation of the primary joint is sufficiently thin to avoid a detrimental effect on mechanical properties of the primary joint.

18. The method of claim 1, wherein a strength of the primary joint is greater than a minimum required by an industry standard.

19. The method of claim 1, further comprising providing a sealant layer between the first structural member and the foil member before forming the intermediate joint.

20. The method of claim 19, wherein the sealant layer is an adhesive.
